(19) United States
(12) Patent Application Publication
(10) Pub. No.: US 2002/0194145 A1
(43) Pub. Date: Dec. 19, 2002

(54) Method and system for financing a renewable energy generating facility

(76) Inventors: Thomas Charles Boucher, N. Ferrisburgh, VT (US); John Charles Quinney, Charlotte, VT (US); Thomas Earl Stoddard, Lincoln, VT (US)

Correspondence Address: MCLANE, GRAF, RAULERSON & MIDDLETON, PROFESSIONAL ASSOCIATION, 900 ELM STREET, P.O. BOX 326, MANCHESTER, NH, 03105-0326, US

(21) Appl. No.: 10/156,392

(22) Filed: May 28, 2002

(51) Int. Cl. G06F 17/60

(52) U.S. Cl. 705/500

(57) ABSTRACT

A method for financing an energy generating facility which generates energy and energy attributes separately tradable therefrom includes determining a purchase price for at least a portion of the energy attributes to be generated in operation of the facility. An agreement is concluded between the developer and a first legal entity under which the first legal entity agrees to pay the developer the purchase price in exchange for the energy attributes. The energy attributes are transferred to the first legal entity in a manner that effectively severs the ownership rights in the energy attributes from the energy. An agreement between the first legal entity and a second legal entity is concluded, under which the second legal entity agrees to accept the energy attributes as a contribution from a purchaser/contributor who purchases the energy attributes. The energy attributes are sold to the purchaser/contributor and are contributed to the second legal entity.

### RELATED APPLICATION

This application claims the benefit under 35 U.S.C. § 119(e) of U.S. provisional application Ser. No. 60/294,090, filed May 29, 2001. Said provisional application is incorporated herein by reference in its entirety.

### BACKGROUND OF THE INVENTION

The present invention relates generally to a financing method and system and, more particularly, to a method and system for financing the construction of a renewable energy generating facility. It finds particular application in conjunction with the financing of wind-powered energy generating facilities and will be described primarily with particular reference thereto. However, it is to be appreciated that the present invention is also amenable to other non-traditional or renewable energy generating facilities, such as solar, geothermal, landfill gas, tidal, and the like.

Non-traditional or renewable energy generating facilities, such as wind farms, generally require a price greater than the wholesale market price for the electrical energy produced in order to cover ongoing costs and realize a desired return on investment. The excess of a wind farm's required price per kilowatt-hour (kWh) over the wholesale market price for energy represents the wind farm's “above-market revenue requirements.”

To illustrate, wind farms in most areas of the United States, in order to be profitable, require a revenue stream from the sale of their output, on a levelized basis, between 3 and 7 cents per kWh. The required price per kWh depends on a number of factors, including the size of the turbines, the number of turbines built at a time, the average wind speed at the location, the ease with which construction materials and vehicles can reach the location, the distance the wind farm's output must be transmitted to reach the electricity grid, etc.

The wholesale market price for electrical energy, on the other hand, generally ranges from 1.5 to 2.5 cents per kWh. To realize its above-market revenue requirements, a wind farm generally must rely on the Production Tax Credit and other available subsidies, and must find a buyer that is willing to pay a premium above wholesale market rates for the energy because it is, and can be sold as, “wind-generated” energy. As the latter is infrequently possible, wind farms often sell their energy locally at the wholesale market rates, and sell their energy attributes to other purchasers, remote or local, to obtain their above-market revenue requirements. As used herein, the term “energy attributes” means any or all rights and interests in and to energy, other than the electrons themselves, namely, attributes, characteristics, and effects that differentiate energy generated by a particular generating facility from energy generated by other generating facilities, including the effects from delivering such energy to the electricity grid at a particular location.

In the absence of a premium buyer for “bundled” energy and associated energy attributes, wind farm generating facilities have typically resorted to a number of methods to realize their above-market revenue requirements. For example, increasing the number of turbines can reduce above-market revenue requirements by increasing economies of scale. Also, the energy generated may be sold as generic energy at market rates (e.g., 2.5 cents per kWh) under a long-term contract, and the associated energy attributes are sold under a short-term contract (e.g., up to 5 years, which is the longest term generally available) to realize the remaining premium. Although such a scheme further reduces the total above-market revenue requirements, it poses a drawback in that the wind farm operator must assume the risk of being able to find a buyer for the energy attributes, at an acceptable price, for the years not covered by the initial energy attributes sale. Wind farm developers without the tolerance for this risk will not proceed with construction.

The present invention provides a financing method and system which overcome the above-referenced problems and others.

### SUMMARY OF THE INVENTION

In a first aspect, a method for financing an energy generating facility is provided. The facility is of a type to be built by a developer and which generates energy having associated energy attributes, which are tradable as a commodity separately from the energy. The method includes determining a purchase price for at least a portion of the energy attributes to be generated in the operation of the facility. An agreement is concluded between the developer and a first legal entity under which the first legal entity agrees to pay the developer the purchase price in exchange for ownership rights in the energy attributes. Ownership rights in the energy attributes are transferred to the first legal entity in a manner that effectively severs the ownership rights in the energy attributes from the energy generated. An agreement between the first legal entity and a second legal entity is concluded, under which the second legal entity agrees to accept the energy attributes as a contribution from a purchaser/contributor who purchases the energy attributes from the first legal entity. The energy attributes are sold to the purchaser/contributor to generate revenue and contributed to the second legal entity.

In another aspect, a method for financing an energy generating facility of a type to be built by a developer and which generates energy having associated energy attributes that are tradable as a commodity separately from the energy includes determining a purchase price for at least a portion of the energy attributes to be generated in the operation of the facility. An agreement is reached between the developer and a legal entity under which the legal entity agrees to accept the energy attributes as a contribution from a purchaser/contributor who purchases the energy attributes from the developer. The energy attributes are sold to the purchaser/contributor to generate revenue and the energy attributes are contributed to the legal entity.

In still a further aspect of the invention, a method for financing an energy generating facility of a type to be built by a developer and which generates energy having associated energy attributes that are tradable as a commodity separately from the energy includes determining a purchase price for at least a portion of the energy attributes to be generated in the operation of the facility and concluding an agreement between the developer and a legal entity, under which the legal entity agrees to pay the developer the purchase price in exchange for ownership rights in the energy attributes. Ownership rights in the energy attributes are transferred to the legal entity in a manner that effectively severs the ownership rights in the energy attributes from the energy generated. The energy attributes are sold to the purchaser/contributor to generate revenue and the energy attributes are contributed to the legal entity.

In still another aspect, a method for financing an energy generating facility of a type to be built by a developer and which generates energy having associated energy attributes that are tradable as a commodity separately from the energy includes calculating a purchase price for at least a portion of the energy attributes to be generated in the operation of the facility. The ownership rights in the energy attributes are transferred to a first legal entity in a manner that effectively severs the ownership rights in the energy attributes from the energy generated. The purchase price is collected from the first legal entity in exchange for ownership rights in the energy attributes. The energy attributes are sold to a purchaser/contributor to generate revenue and the energy attributes are transferred to a second legal entity.

In another aspect, a system for financing an energy generating facility of a type to be built by a developer and which generates energy having associated energy attributes that are tradable as a commodity separately from the energy generated includes a computer-based information handling system adapted to:

calculate a purchase price for at least a portion of the energy attributes to be generated in the operation of the facility;

transfer the ownership rights in the energy attributes to a first legal entity in a manner that effectively severs the ownership rights in the energy attributes from the energy generated;

collect the purchase price from the first legal entity in exchange for ownership rights in the energy attributes;

sell the energy attributes to a purchaser/contributor to generate revenue; and

transfer the energy attributes to a second legal entity.

In yet another aspect, a computer readable medium has contents for causing a computer-based information handling system to perform steps for financing an energy generating facility of a type to be built by a developer, the facility being further of a type which generates energy having associated energy attributes, the energy attributes being tradable as a commodity separately from the energy, the steps comprising:

calculating a purchase price for at least a portion of the energy attributes to be generated in the operation of the facility;

transferring the ownership rights in the energy attributes to a first legal entity in a manner that effectively severs the ownership rights in the energy attributes from the energy generated;

collecting the purchase price from the first legal entity in exchange for ownership rights in the energy attributes;

selling the energy attributes to a purchaser/contributor to generate revenue; and

transferring the energy attributes to a second legal entity from the purchaser/contributor.

In another aspect, the invention provides a renewable energy generating facility that has been financed, at least in part, by a method or system in accordance with this teaching.

One advantage of the present invention is that it provides an effective financing mechanism for promoting the construction of renewable energy generating facilities.

Another advantage of the present invention is that it enables individuals or businesses to help cause the construction of new renewable energy generating capacity, thus causing environmental benefits.

Yet another advantage of the present invention resides in the environmental and/or charitable benefits obtained by contribution of the purchased energy attributes to a charitable organization.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 illustrates a method according to a first embodiment the present invention wherein the energy attributes are transferred to a third party prior to purchase by purchasers/contributors.

FIG. 2 illustrates a method according to a second embodiment of the present invention wherein the energy attributes are not transferred to a third party prior to purchase by purchasers/contributors.

FIG. 3 illustrates a method according to a third embodiment of the present invention wherein the energy attributes are transferred directly to a charitable organization prior to purchase by purchasers/contributors.

### DETAILED DESCRIPTION OF THE PREFERRED EMBODIMENTS

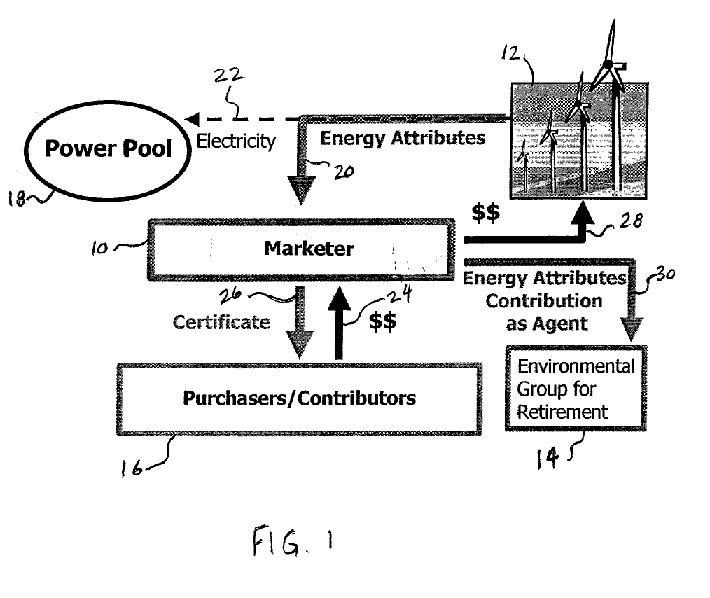

Referring to FIG. 1, an actor 10 receives energy attributes 20 from a developer 12 of a renewable energy facility for subsequent transfer to a charitable organization 14, which may be, for example, an environmental advocacy group or the like. The actor 10 is a person or entity other than the developer 12 and the charitable organization 14, and may be a marketer, marketing company or the like.

The actor 10 enters into a binding agreement with the developer 12 of a renewable energy facility prior to construction of the facility. As used herein, the term “facility” refers not only to a renewable energy facility in its entirety, but also to any portion of a renewable facility supported by revenues from the actor as described below, as well as renewable energy generating capacity to be added to an existing generating facility.

Pursuant to the agreement between the actor 10 and the developer 12, the actor becomes bound to pay the developer an amount 28 to cover some or all of the above-market revenue requirements of the facility at a mutually agreeable time or times, preferably at or about the time the facility commences initial commercial operation.

The amount 28 to be paid by the actor 10 may be any mutually agreeable purchase price. In a preferred embodiment, the amount 28 paid is the discounted present value of the amount (or portion thereof) by which the developer's revenue requirements over the expected operational life of the facility exceed the wholesale market price for the energy, sold as generic energy, that the facility is expected to generate during its operational life.

In consideration for the payment 28 (or the obligation to make the payment 28) the developer 12 sells or transfers to the actor 10 the present ownership of some or all right, title, or interest in and to energy attributes 20 associated with the energy generated by the facility over its operational life.

To illustrate, energy generated by a wind turbine has the following energy attributes, among others: (i) it was generated by a wind turbine; (ii) it was generated at a particular time; (iii) the turbine was connected to a particular electricity grid; (iv) the generation of such energy resulted in no emissions of pollutants or greenhouse gases; and (v) the delivery of such energy to the grid reduced the amount of energy that would otherwise have been needed to be generated by other generators on that grid, including fossil fuel-fired generators, and so caused an approximately quantifiable reduction in the amount of pollutants, greenhouse gases, and/or particulates that would otherwise have been emitted in meeting the grid's energy needs.

The energy attributes 20 are “severed” from the energy 22 that generates them by selling or otherwise transferring such energy, e.g., to pool 18, in transactions in which the source of the energy 22 is not disclosed to the transferee, or in which the transferee is put on notice that it is acquiring legal ownership of only the generic energy commodity, and has no rights to the energy attributes. Once so severed, energy attributes can be traded as a commodity separately from the energy that generated them.

The energy attributes 20 acquired by the actor 10 in accordance with the invention may include, for example: (i) all energy attributes to be generated by the facility during its operational life; (ii) all of the energy attributes to be generated by a specified portion of the facility's generating capacity during its operational life; (iii) all of the energy attributes to be generated by the facility during a specified period; (iv) all of the energy attributes to be generated by a specified portion of the facility's generating capacity during a specified period; (v) any one or more energy attributes, such as carbon dioxide emissions reductions, to be generated by the facility (or by a specified portion of the facility's generating capacity) during the facility's operational life, or during a specified period thereof; or (vi) a specified quantity of energy attributes. A specified quantity of energy attributes may be specified by a number of methods, for example, as the energy attributes of a specified quantity (e.g., megawatt-hours) of energy generated, a specified quantity of emissions reductions resulting from the operation of the facility, and so forth.

In an alternative embodiment, the actor 10 may purchase from the developer 12 the energy attributes 20 together with the energy 22 that generates them, and sell the energy 22 to one or more third parties, e.g., at the wholesale or market price, while retaining the energy attributes 20 as detailed above. In another alternative embodiment, the actor 10 may purchase the energy attributes 20, with or without the underlying energy 22, after the facility 12 has been constructed.

With continued reference to FIG. 1, the actor 10 enters into a binding agreement with one or more charitable organizations 14 pursuant to which the charitable organization agrees to accept contributions 30 from individuals and/or businesses 16 (hereinafter referred to as “purchasers/contributors”) who purchase for an amount 24, from the actor 10, energy attributes 20 or the present rights to energy attributes 20 to be delivered in the future. The contributions 30 to the charitable organization of the energy attributes, or present rights thereto, purchased by the purchasers/contributors 16 are accepted by the charitable organization 14 for a charitable and/or environmentally beneficial purpose.

The contribution 30 of energy attributes or present rights thereto may be effected by the purchasers/contributors 16 directly or, alternatively, by and through the actor 10 acting as an agent of the purchasers/contributors 16.

Exemplary charitable uses of the contribution 30 include, for example: (i) permanent retirement of the energy attributes or present rights thereto; (ii) permanent retirement of one or more components thereof, such as the carbon dioxide emissions reductions; (iii) use of the energy attributes or present rights thereto to acquire and retire rights to a specific quantity of reductions in emissions of pollutants or greenhouse gases, or one or more components thereof, such as carbon dioxide emissions reductions; or (iv) any other use of the energy attributes or present rights thereto to further the charitable purposes of the charitable organization 14.

The charitable organization 14 also agrees to retire the contributed energy attributes or otherwise treat them as described above. As used herein, the terms “retire” and “retirement” refer to the act of retiring property; that is, to ensure that no further use is made thereof or value realized therefrom. Retirement of the energy attributes 20 received as contributions 30 may be accomplished by a number of methods. Exemplary methods for retirement of the contributed energy attributes 30 or any rights thereto include, for example, the destruction of any tangible representations thereof; making no further use and effecting no further transfer thereof, for value or otherwise; causing such retirement to be recorded with a duly constituted authority; or any other legally effective manner. The charitable group 14 may effect such retirement itself, or, by and through the actor acting as its agent.

Preferably, the charitable organization 14 also delivers to each purchaser/contributor 16 a certificate 26, which may be a receipt, certificate, or other communication 26, written or otherwise, evidencing the purchase 24 of the energy attributes 20 and the contribution 30 thereof to the charitable organization. The receipt 26 may be, for example, a legally required receipt. If no such receipt is legally required, the receipt 26 may be any mutually agreeable receipt, certificate, or other communication evidencing the same, if the actor 10 and the charitable organization 14 so desire.

The actor 10 sells the present ownership of a portion of the energy attributes 20 generated or to be generated in the future by the facility 12 to one or more purchasers/contributors 16, each of which may be an individual and/or business. The actor 10 may sell the energy attributes directly or indirectly through third-party resellers. The purchased present ownership interest constitutes purchased property, and may be quantified by a number of methods. For example, the purchased property may be quantified as a stream of energy attributes to be generated by a specified portion of the generating capacity of the facility. Alternatively, the purchased property may be quantified as a specified quantity of energy attributes generated or to be generated by the facility, and may be expressed in terms of megawatt-hours, quantities of emissions reductions, and so forth.

During or in connection with the sale of such present ownership of energy attributes to the purchaser/contributor 16, the actor 10 obtains the authorization of the purchaser/contributor to contribute the purchased property to the charitable organization 14 and/or notifies the purchaser/contributor that the charitable organization has agreed to accept contribution of the purchased property.

For example, the actor 10 may, in connection with the sale, obtain the authorization of the purchaser/contributor 16 to contribute the purchased property to a specified charitable organization 14, on behalf of and as an agent of the purchaser/contributor 16, for permanent retirement of the energy attributes or treatment thereof as detailed above. The actor 10 then contributes such purchased property to the specified charitable organization for such purpose on behalf of and as an agent of the purchaser/contributor 16.

Alternatively, the actor 10 notifies the purchaser/contributor 16 that the charitable organization 14 has agreed with the actor 10 to accept the contribution to it of all purchased property purchased by the purchasers/contributors 16 from the actor 10 for use or treatment in the manner specified above. The actor 10 provides the purchasers/contributors 16 with a mechanism to effect such contribution, such as providing a certificate or other instrument 26 evidencing ownership of the purchased property for the purchasers/contributors 16 to deliver to the charitable organization 14.

Again, the actor 10 and/or the specified charitable organization 14 may optionally issue to the purchaser/contributor 16 a certificate 26, which may be a receipt, certificate, other communication, written or otherwise, identifying the purchased property and evidencing the purchase and contribution thereof by the purchaser/contributor 16 to the charitable organization for permanent retirement or other use of the energy attributes.

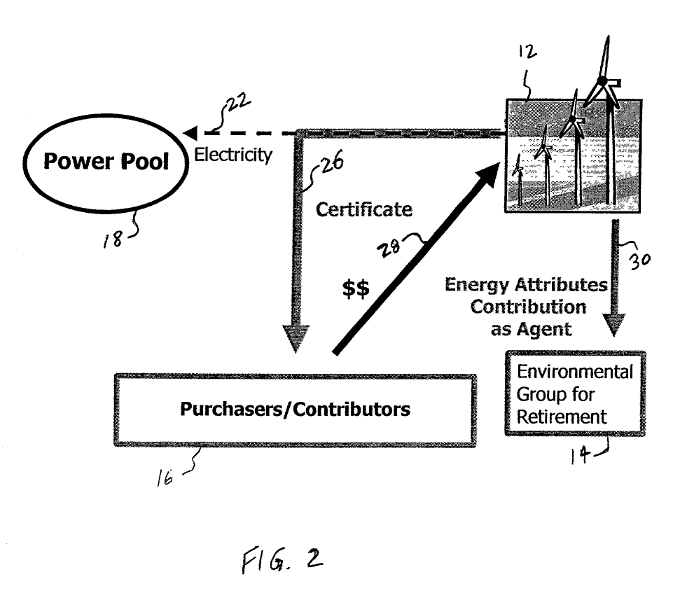

Referring now to FIG. 2, an further embodiment of the present invention is illustrated wherein a developer 12 of a renewable energy facility deals directly with a charitable organization 14 and purchasers/contributors 16 without using a third party actor 10 (FIG. 1).

The developer 12, prior to construction of the facility, markets energy attributes 30 to cover some or all of the above-market revenue requirements of the facility. The developer 12 enters into a binding agreement with one or more charitable organizations 14 pursuant to which the charitable organization agrees to accept contributions 30 from purchasers/contributors 16 who purchase, for an amount 24, energy attributes or the present rights to energy attributes to be delivered in the future. The contributions 30 are accepted by the charitable organization 14 for retirement and/or other charitable/environmental purpose as described above.

The contribution 30 of energy attributes or present rights thereto may be effected by the purchasers/contributors 16 directly or, alternatively, by and through the developer 12 acting as an agent of the purchasers/contributors 16. The charitable organization 14 also agrees to retire the contributed energy attributes or otherwise treat them as described above. The charitable organization 14 may effect such retirement itself, or, by and through the director 12 acting as its agent.

Preferably, the charitable organization 14 also delivers to each purchaser/contributor 16 a receipt, certificate, or other communication 26, written or otherwise, evidencing the purchase and contribution 30 of the energy attributes. The receipt 26 may be, for example, a legally required receipt. If no such receipt is legally required, the receipt 26 may be any mutually agreeable receipt, certificate or other communication evidencing the same, if the developer 12 and the charitable organization 14 so desire.

The developer 12 sells the present ownership of a portion of the energy attributes generated or to be generated in the future by the facility to one or more purchasers/contributors 16, each of which may be an individual and/or business. The director 12 may sell the energy attributes directly or indirectly through third-party resellers. The purchased property (i.e., purchased present ownership interest), may be specified or quantified by any number of methods, including those described above by way of reference to FIG. 1.

During or in connection with the sale of such present ownership of energy attributes to the purchaser/contributor 16, the developer 12 obtains the authorization of the purchaser/contributor 16 to contribute the purchased property to the charitable organization 14 and/or notifies the purchaser/contributor that the charitable organization has agreed to accept contribution of the purchased property.

For example, the developer 12 may, in connection with the sale, obtain the authorization of the purchaser/contributor 16 authorization to contribute the purchased property to a specified charitable organization 14, on behalf of and as an agent of the purchaser/contributor 16, for permanent retirement of the energy attributes or treatment thereof as detailed above. The developer 12 then contributes such purchased property to the specified charitable organization for such purpose on behalf of and as an agent of the purchaser/contributor 16.

Alternatively, the developer 12 notifies the purchaser/contributor 16 that the charitable organization 14 has agreed with the developer 12 to accept the contribution to it of all purchased property purchased by the purchasers/contributors 16 from the actor 10 for use or treatment in the manner specified above. The developer 12 provides the purchasers/contributors 16 with a mechanism to effect such contribution, such as providing a certificate 26 evidencing ownership of the purchased property for the purchasers/contributors 16 to deliver to the charitable organization 14.

Again, the developer 12 and/or the specified charitable organization 14 may optionally issue to the purchaser/contributor 16 a receipt, certificate or other communication 26, written or otherwise, identifying the purchased property and evidencing the purchase and contribution thereof by the purchaser/contributor 16 to the charitable organization for permanent retirement or other use of the energy attributes.

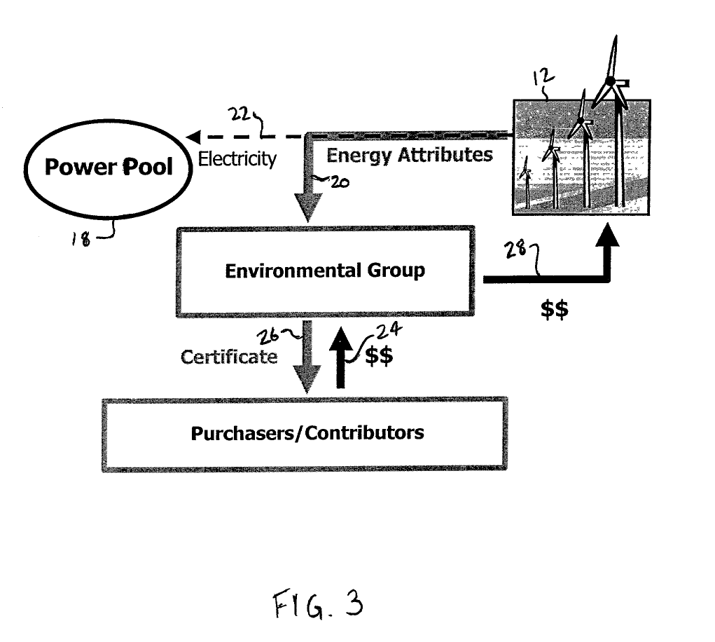

Referring now to FIG. 3, yet another embodiment of the present invention is illustrated wherein a charitable organization 14 receives energy attributes from a developer 12 of a renewable energy facility and markets such energy attributes directly to purchasers/contributors 16. In exchange for the energy attributes, the charitable organization 14 enters into a binding agreement with the developer 12 of a renewable energy facility prior to construction of the facility.

Pursuant to the agreement between the charitable organization 14 and the developer 12, the charitable organization becomes bound to pay the developer an amount 28 to cover some or all of the above-market revenue requirements of the facility at a mutually agreeable time or times, preferably at or about the time the facility commences initial commercial operation.

The amount 28 to be paid by the charitable organization 14 may be any mutually agreeable purchase price. In a preferred embodiment, the amount 28 paid is the discounted present value of the amount (or portion thereof) by which the developer's revenue requirements over the expected operational life of the facility exceed the market price for the energy, sold as generic energy, that the facility is expected to generate during its operational life.

In consideration for the payment 28 (or the obligation to make the payment 28) the developer 12 sells or transfers to the charitable organization 14 the present ownership of some or all right, title, or interest in and to energy attributes 20, as defined and described above, associated with the energy generated by the facility over its operational life.

In an alternative embodiment, the charitable organization 14 may purchase from the developer 12 the energy attributes 20 together with the energy 22 that generates them, and sell the energy 22 to one or more third parties, e.g., at the wholesale or market price, while retaining the energy attributes 20 as detailed above. In another alternative embodiment, the charitable organization 14 may purchase the energy attributes 20, with or without the underlying energy 22, after the facility 12 has been constructed.

The charitable organization 14 sells the present ownership of a portion of the energy attributes 20 generated or to be generated in the future by the facility 12 to one or more purchasers/contributors 16, each of which may be an individual and/or business.

The charitable organization 14 may sell the energy attributes directly or indirectly through third-party resellers. Again, the purchased present ownership interest constitutes purchased property, and may be quantified in the manner described above.

During or in connection with the sale of such present ownership of energy attributes to the purchaser/contributor 16, the charitable organization 14 obtains the authorization of the purchaser/contributor 16 to contribute the purchased property to itself and/or notifies the purchaser/contributor that the charitable organization has agreed to accept contribution of the purchased property.

For example, the charitable organization 14 may, in connection with the sale, obtain the authorization of the purchaser/contributor 16 authorization to contribute the purchased property to itself on behalf of and as an agent of the purchaser/contributor 16, for permanent retirement of the energy attributes or treatment thereof as detailed above. The charitable organization 14 then contributes such purchased property to itself for such purpose on behalf of and as an agent of the purchaser/contributor 16.

Alternatively, the charitable organization 14 notifies the purchaser/contributor 16 that it commits to accept the contribution to it of all purchased property purchased by the purchasers/contributors 16 from the charitable organization 14 for use or treatment in the manner specified above. The charitable organization 14 provides the purchasers/contributors 16 with a mechanism to effect such contribution, such as providing a certificate 26 evidencing ownership of the purchased property for the purchasers/contributors 16 to deliver to the charitable organization 14.

The charitable organization 14 may or may not issue to the purchaser/contributor a receipt, certificate or other communication identifying the purchased property, and evidencing the purchaser/contributor's purchase thereof and the purchaser/contributor's contribution thereof to it for permanent retirement of the energy attributes.

Preferably, the energy attributes are transferred to a third party actor that is a person or entity other than the developer or the charitable organization, as illustrated in the embodiment of FIG. 1. Advantageously, the actor has energy supply contracting experience so as to ensure that it actually acquires present legal ownership of valid energy attributes to be generated by the facility, and that the facility is committed to continue to cause the facility to generate energy at the highest rate and for the longest possible period. Few charitable organizations have this experience. Also, the actor advantageously also possesses market understanding and marketing skills to reach and appeal to the greatest number of individuals and businesses as potential purchasers/contributors. Few developers or charitable organizations have such understanding or skills. Most advantageously, the actor is a marketing company (“marketer”) experienced in the renewable energy industry.

The marketer should develop long-term relationships with developers with strong creditworthiness, a strong business reputation, a strong market presence, etc. This gives the marketer access to a greater variety of potential facilities, enabling the marketer to choose among facilities that have the best economics. The present invention works best when the facility being supported has the lowest non-zero above-market revenue requirements, and/or is to be built in an area that relies heavily on fossil fuel-fired generation facilities. In this manner, increased emissions reductions per customer dollar can be realized.

Advantageously, the present invention is employed in conjunction with the construction of wind-powered generation facilities located in regions with high wind resource potential since wind facilities generally have the best balance between relatively low above-market revenue requirements and relatively high consumer appeal.

Renewable generators with lower above-market revenue requirements generally demand a lower price for their energy attributes. Thus, less money is required to be paid to the generator to make its facility economically viable. As set forth above, wind farms generally require between 3-7 cents per kWh to be profitable. By contrast, photovoltaic generating facilities, which have considerable consumer appeal, generally require at least 20 cents per kWh to be profitable, depending primarily on location.

Landfill gas and geothermal facilities, on the other hand, generally have above-market revenue requirements at or below those of wind farms. However, such facilities generally have considerably less consumer appeal than wind-powered energy generating facilities. Thus, it is generally more difficult to convince consumers to purchase energy attributes from such facilities.

Most advantageously, the marketer agrees, prior to construction of the facility, to acquire the all or substantially all of the facility's energy attributes before construction of the facility, or that portion of the facility supported by revenues from the marketer. An assurance that the marketer will receive its above-market revenue requirements can be an important factor, and in some cases a critical or necessary factor, in the developer's decision to build the facility or portion thereof.

Advantageously, the marketer also sells the energy attributes to its purchasers/contributors prior to construction. This enables the marketer to claim accurately that the purchasers/contributors helped cause the facility, or such portion, to be built, and helped cause new environmental benefits, which has considerable appeal to consumers and within the environmental community.

While it is contemplated that energy attributes from a facility can be sold after the facility is constructed, doing so limits the marketer to claiming merely that its purchasers/contributors “support” generation by a renewable energy generating facility. Furthermore, after the facility is built, it will likely generate the same amount of environmental benefits with or without their purchase of the energy attributes.

To illustrate, wind farms have very low marginal operations costs. They require no fuel to generate energy, so ongoing costs typically involve only maintenance and repair. In addition, most wind farms sell their energy output either into the local spot market or under long-term output contracts pursuant to which the buyer agrees to purchase all the energy the wind farm generates. Thus, for the most part, existing wind farms generate their energy when the wind blows, not when people buy their energy attributes. As a consequence, buying energy attributes from existing wind farms would not be likely to cause anything to happen that wouldn't happen anyway. By comparison, if the marketer agrees in advance of construction to purchase the wind farm's entire life-of-facility energy attributes output promptly after it achieves commercial operations, in accordance with the preferred embodiment of the present invention, the marketer's commitment can be an important causative factor in making the wind farm economically viable and helping it proceed to construction. This helps drive the construction of new wind farms, thereby helping to create new environmental benefits that would not necessarily otherwise happen. Likewise, selling the wind farm's energy attributes prior to its commercial operations enables each of the purchasers to help drive the construction of the wind farm, and in so doing, helping to create new environmental benefits, by at least partially enabling the marketer to fulfill its commitment to the wind farm.

Preferably, the marketer acquires only energy attributes from the developer, leaving the developer to sell the energy from which the energy attributes are derived to third parties. This avoids the need to meet more stringent creditworthiness requirements than are necessary, and avoids unnecessary transaction costs. Buying and selling only the energy attributes enables the marketer to sell into a national market, e.g., without being restricted to selling energy only in those States that have permitted competition in their retail electricity markets.

The developer advantageously sells or transfer the energy from which the marketer's energy attributes are derived in transactions in which the identity of the generating facility and the energy resource used to generate the energy (e.g., wind), are not disclosed or reported to the transferee or any third party, in writing or otherwise. For example, this may form a part of the developer's agreement with the marketer. Transferring the energy to the transferee in this restricted manner prevents the transferee from obtaining sufficient information to form a conflicting claim that it purchased any of the energy attributes of such energy. Alternatively, the marketer should ensure that it has the exclusive legal rights to the energy attributes, and obtain the developer's agreement not to make any conflicting claims thereto, and not to transfer any conflicting rights to the energy attributes to any third party. Either method ensures that the energy attributes the marketer acquires are not “double counted,” potentially leading to a loss of credibility with consumers.

Advantageously, the marketer acquires from the developer the present ownership of all energy attributes to be generated in the future by the facility, or a specified portion of the facility's generating capacity, during its expected operating life. Projections of the facility's output can be calculated in known manner, for example, by the developer, for use in obtaining financing and negotiating its power purchase agreement. To ensure accuracy, the marketer may advantageously ensure that it is given the same projections as the developer provides to the project lender. In this manner, the marketer can sell to its purchasers/contributors a stream of energy attributes that continues, e.g., for 20 or more years, rather than a discrete number of megawatt-hours of energy attributes. It also enables the marketer to acquire the energy attributes at significantly less cost, by paying the discounted present value of energy attributes to be generated in the future. Finally, by purchasing all of the facility's projected energy attributes, the marketer is able to offer a substantial enough sum of money, as the purchase price, to play a material role in the facility's ultimate success, thereby enabling it to claim credibly that it is “helping build” the facility.

Preferably, the marketer commits to pay the developer for the Energy attributes only after the facility reaches commercial operations. This advantageously avoids the risk that the facility will fail during the development stage, and enables the marketer to substitute another facility to meet its obligations to its customers.

Also, the marketer should obtain the developer's agreement to use commercially reasonable efforts to continue operating the facility during the entire term of the marketer's purchase of the energy attributes. This minimizes the risk that the facility will produce fewer kWh of energy attributes than estimated.

The marketer should sell to its customers the present ownership of all energy attributes to be generated by a specified portion of the facility's generating capacity during the entire term of the marketer's purchase thereof. This enables the marketer to engender in its purchasers/contributors a stronger feeling of “ownership” of the facility they helped cause to be built, and so has greater marketing appeal. It also results in the purchasers assuming the risk that the facility will produce fewer kWh of energy attributes than estimated.

Advantageously, the marketer should market the energy attributes not as a product, but rather, as a set of services that provide individuals and businesses the ability to fight air pollution and/or climate change by helping to build new renewable energy facilities and either keeping carbon dioxide out of the air or offsetting the carbon dioxide emissions their own activities cause. This is something individuals and most businesses generally cannot do without the marketer's services, and it keeps the message simple. Current marketing attempts are generally not successful because they position the energy attributes they sell as “virtual” electricity products, which consumers do not understand.

The marketer can advantageously market its services through environmental advocacy organizations and socially responsible businesses who have access to environmentally conscientious individuals and businesses who are their customers or members. The present invention comprises a unique set of services that will be much easier to market and sell with the trust that inheres in a pre-existing relationship between a customer/member and a business or environmental organization he or she trusts.

The charitable organization is preferably chosen by the marketer and may advantageously be one or more well-known charitable organizations with a strong brand and/or a charitable purpose that is focused on environmental issues related to renewable energy. Most preferably, the charitable organization is an organization qualified under Section 501(c)(3) of the Internal Revenue Code. This increases the marketer's credibility in the market, and will ensure that its purchasers/contributors' contributions are tax-deductible.

The marketer preferably, during the purchase transaction, obtains the purchaser/contributor's consent to the marketer donating the purchased property to the charitable organization on the purchaser/contributor's behalf. This makes the transaction simpler for the purchaser/contributor, and makes reporting the quantities of energy attributes retired much easier.

The marketer preferably also obtains the agreement of the charitable organization, or otherwise causes it to commit to the marketer's customers, that it will retire the Energy attributes associated with the purchased property, thus causing the environmental benefits to be permanent. Alternatively, the marketer may obtain the agreement of the charitable organization, or cause it to commit to the marketer's customers, that it will either retire such Energy attributes or use them in ways that will keep as much of a specific pollutant or greenhouse gas out of the air, such as carbon dioxide, as retiring them would. This gives the charitable organization control and discretion over its use of the donated property, while ensuring that the marketer's customers, by making the donation, will cause carbon dioxide or the specific pollutants to be kept out of the atmosphere.

The marketer may advantageously quantify the amount of carbon dioxide or pollutants each purchaser/contributor keeps out of the atmosphere by reference to the published data (e.g., the Environmental Protection Agency's EGRID database) regarding emissions of generators within the regional grid in which the facility delivers its energy, and whose energy is expected to be offset by the facility's energy.

The marketer may advantageously deliver to each purchaser/contributor a certificate identifying the portion (e.g., in kilowatts or kilowatt-hours of generating capacity) of the facility the purchaser/contributor's purchase helped cause to be built. The certificate may also constitute a written acknowledgement from the charitable organization of its receipt of the purchased property and its commitment to treat the purchased property as agreed or as promised to the marketer's customers. This gives the purchaser/contributor something tangible to represent the Purchaser/contributor's help in fighting pollution, climate change, etc., as well as provides a record of the contribution for the purchaser/contributor's tax records.

The charitable organization may (e.g., pursuant to its agreement with the marketer) report the emissions reductions that result from its retirement of the energy attributes to the Department of Energy (e.g., under Section 1605(b) of the Energy Policy Act of 1992) and/or any other duly constituted authority. Alternatively, the marketer may perform such reporting on the charitable organization's behalf.

The marketer may make ongoing estimated emissions reductions data, as well as facility construction progress and other information, available to its purchasers/contributors, e.g., on a website or through other easily accessible media. This enables the marketer to reinforce the positive environmental effects of their purchases, and increases the likelihood of repeat sales.

In accordance with a further aspect of the present invention, a financing system for a computer-based information handling may be tangibly embodied as a software implemented by and executing thereon. Such a software system may be employed to perform, facilitate, or streamline steps or components of the present invention, such as the estimation or forecasting of energy attribute value or pricing, and the transfer, sale, and/or contribution of the energy attributes in accordance with this teaching. Thus, one of the embodiments of the invention can be implemented as sets of instructions resident in the main memory of one or more computer systems. Until required by the computer system, the set of instructions may be stored in another computer readable memory such as a hard disk drive or a removable memory such as an optical disk, a floppy disk, a personal computer memory card, and so forth. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

### EXAMPLE

An illustrative example of the present invention and comparison to the traditional model is given below, based on the simplified financial assumptions shown in TABLE 1.

TABLE 1
Example Wind Farm Financial Assumptions:

| | |
|---|---|
| Turbines: | One 900 kW Wind Turbine |
| Total Installed Cost: | $1,000,000 |
| Annual Revenue | $104,842 (to cover ongoing costs and return on |
| Requirement Net | investment) |
| of Tax Credits: | |
| Expected | 2,759,000 kWh/year |
| Generation: | |
| Required $/kWh: | $.038 |
| Wholesale Market | $.025 |
| Energy Price/kWh | |
| Above-Market | $.013 |
| Revenue | |
| Requirements: | |
| Market: | No available buyer willing to pay a premium for the |
| | wind farm's energy as “wind-generated” energy |
| | (i.e., still “bundled” with its energy attributes) |

Based on the foregoing simplified assumptions, the exemplary wind farm needs to obtain 3.8 cents per kWh for its energy in order to cover ongoing costs and realize its desired return on investment. As detailed above, under the traditional model, a developer would likely increase the number of turbines; sell the energy produced as generic energy and at market rates under a long-term contract; sell energy attributes under a short-term contract; and assume the risk of being able to find a buyer for the energy attributes, at an acceptable price, for the years not covered by the initial energy attributes sale. A wind farm developer without the tolerance for this risk would not proceed.

The present invention, however, would enable the exemplary wind farm to be economically viable and proceed to construction, as follows. The exemplary wind farm would sell its energy as generic energy at 2.5 cents per kWh under a long-term contract. The marketer would commit to pay the exemplary wind farm, once it reaches commercial operations, $315,067 in exchange for the rights to all of the energy attributes estimated to be generated by the exemplary wind farm over a 25-year term, i.e., its expected operating life.

The $315,067 payment represents the negotiated discounted present value, (12% per year assumed here), of 2,759,000 kWh per year times 1.3 cents per kWh, for 25 years. Assuming the negotiated the discount rate approximates the exemplary wind farm's weighted cost of capital, it is the functional equivalent of the exemplary wind farm being paid 1.3 cents per kWh on an ongoing basis (when and as generated) for all of the energy attributes the exemplary wind farm is expected to generate over its expected operating life of 25 years.

This upfront payment also represents an early cash-back feature for a sizable portion of the equity required to finance the project. This, coupled with its receipt of 2.5 cents per kWh of its generic energy under the long-term energy sale contract, provides the exemplary wind farm exactly what it needs to become economically viable and can proceed with construction. In addition, it has the added value that the exemplary wind farm reduces its risk that it's generation performance through time is below estimates; that is, by paying in advance for all the energy attributes based on their estimated quantity, the marketer assumes the risk that the generation will be less than estimated for this portion of the revenue stream.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A method for financing an energy generating facility of a type to be built by a developer, said facility being further of a type which generates energy having associated energy attributes, the energy attributes being tradable as a commodity separately from said energy, said method comprising:
determining a purchase price for at least a portion of said energy attributes to be generated in the operation of said facility;
concluding an agreement between said developer and a first legal entity, under which said first legal entity agrees to pay the developer said purchase price in exchange for ownership rights in said energy attributes;
transferring said ownership rights in said energy attributes to said first legal entity in a manner that effectively severs said ownership rights in said energy attributes from the energy generated;
concluding an agreement between said first legal entity and a second legal entity, under which said second legal entity agrees to accept said energy attributes as a contribution from a purchaser/contributor who purchases said energy attributes from said first legal entity;
selling said energy attributes to said purchaser/contributor to generate revenue; and
contributing said energy attributes to said second legal entity.

2. The method according to claim 1, wherein the facility is a wind farm.

3. The method according to claim 1, wherein said transferring and said selling are performed prior to construction of said facility.

4. The method of claim 1, further comprising:
employing the revenue generated from the sale of said energy attributes to the purchaser/contributor to finance at least a portion of construction and/or operating costs of said facility.

5. The method of claim 1, wherein said energy attributes are selected from the group consisting of:
(i) all of the energy attributes to be generated by the facility during its operational life;
(ii) all of the energy attributes to be generated by a specified portion of the facility's generating capacity during its operational life;
(iii) all of the energy attributes to be generated by the facility during a specified period;
(iv) all of the energy attributes to be generated by a specified portion of the facility's generating capacity during a specified period;
(v) one or more energy attributes to be generated by at least a portion of the facility's generating capacity during at least a portion of the facility's operational life; and
(vi) a specified quantity of energy attributes.

6. The method of claim 5, wherein said a specified quantity of energy attributes is specified in terms of one or both of: (i) a specific quantity of energy generated; and (ii) a specific quantity of emissions reductions resulting from operation of said facility.

7. The method of claim 5, wherein said one or more energy attributes to be generated includes carbon dioxide emissions reductions resulting from operation of said facility.

8. The method of claim 1, wherein the first legal entity is selected from a business and an individual.

9. The method of claim 8, wherein the first legal entity is a marketing company.

10. The method of claim 1, wherein the second legal entity is selected from a charitable organization and an environmental group.

11. The method of claim 1, further comprising at least one of:
(i) retiring at least a portion of said energy attributes;
(ii) use of said energy attributes by the second legal entity to acquire and retire rights to a specific quantity of reductions of a greenhouse gas, a pollutant, or both; and
(iii) use of the energy attributes by the second legal entity to further a charitable and/or environmental purpose.

12. A method for financing an energy generating facility of a type to be built by a developer, said facility being further of a type which generates energy having associated energy attributes, the energy attributes being tradable as a commodity separately from said energy, said method comprising:
determining a purchase price for at least a portion of said energy attributes to be generated in the operation of said facility;
concluding an agreement between said developer and a legal entity, under which said legal entity agrees to accept said energy attributes as a contribution from a purchaser/contributor who purchases said energy attributes from said developer;
selling said energy attributes to said purchaser/contributor to generate revenue; and
contributing said energy attributes to said legal entity.

13. The method according to claim 12, wherein the facility is a wind farm.

14. The method according to claim 12, wherein said selling is performed prior to construction of said facility.

15. The method of claim 12, further comprising:
employing the revenue generated from the sale of said energy attributes to the purchaser/contributor to finance at least a portion of construction and/or operating costs of said facility.

16. The method of claim 12, wherein said energy attributes are selected from the group consisting of:
(i) all of the energy attributes to be generated by the facility during its operational life;
(ii) all of the energy attributes to be generated by a specified portion of the facility's generating capacity during its operational life;
(iii) all of the energy attributes to be generated by the facility during a specified period;
(iv) all of the energy attributes to be generated by a specified portion of the facility's generating capacity during a specified period;
(v) one or more energy attributes to be generated by at least a portion of the facility's generating capacity during at least a portion of the facility's operational life; and
(vi) a specified quantity of energy attributes.

17. The method of claim 16, wherein said a specified quantity of energy attributes is specified in terms of one or both of: (i) a specific quantity of energy generated; and (ii) a specific quantity of emissions reductions resulting from operation of said facility.

18. The method of claim 16, wherein said one or more energy attributes to be generated includes carbon dioxide emissions reductions resulting from operation of said facility.

19. The method of claim 12, wherein said legal entity is selected from a charitable organization and an environmental group.

20. The method of claim 12, further comprising at least one of:
(i) retiring at least a portion of said energy attributes;
(ii) use of said energy attributes by the second legal entity to acquire and retire rights to a specific quantity of reductions in emissions of a greenhouse gas, a pollutant, or both; and
(iii) use of the energy attributes by the second legal entity to further a charitable and/or environmental purpose.

21. A method for financing an energy generating facility of a type to be built by a developer, said facility being further of a type which generates energy having associated energy attributes, the energy attributes being tradable as a commodity separately from said energy, said method comprising:
determining a purchase price for at least a portion of said energy attributes to be generated in the operation of said facility;
concluding an agreement between said developer and a legal entity, under which said legal entity agrees to pay the developer said purchase price in exchange for ownership rights in said energy attributes;
transferring said ownership rights in said energy attributes to said legal entity in a manner that effectively severs said ownership rights in said energy attributes from the energy generated;
selling said energy attributes to said purchaser/contributor to generate revenue; and
contributing said energy attributes to said legal entity.

22. The method according to claim 21, wherein the facility is a wind farm.

23. The method according to claim 21, wherein said transferring and said selling are performed prior to construction of said facility.

24. The method of claim 21, further comprising:
employing the revenue generated from the sale of said energy attributes to the purchaser/contributor to finance at least a portion of construction and/or operating costs of said facility.

25. The method of claim 21, wherein said energy attributes are selected from the group consisting of:
(i) all of the energy attributes to be generated by the facility during its operational life;
(ii) all of the energy attributes to be generated by a specified portion of the facility's generating capacity during its operational life;
(iii) all of the energy attributes to be generated by the facility during a specified period;
(iv) all of the energy attributes to be generated by a specified portion of the facility's generating capacity during a specified period;
(v) one or more energy attributes to be generated by at least a portion of the facility's generating capacity during at least a portion of the facility's operational life; and
(vi) a specified quantity of energy attributes.

26. The method of claim 25, wherein said a specified quantity of energy attributes is specified in terms of one or both of: (i) a specific quantity of energy generated; and (ii) a specific quantity of emissions reductions resulting from operation of said facility.

27. The method of claim 25, wherein said one or more energy attributes to be generated includes carbon dioxide emissions reductions resulting from operation of said facility.

28. The method of claim 21, wherein the legal entity is selected from a charitable organization and an environmental group.

29. The method of claim 21, further comprising at least one of:
(i) retiring at least a portion of said energy attributes;
(ii) use of said energy attributes by the legal entity to acquire and retire rights to a specific quantity of reductions in emissions of a greenhouse gas, a pollutant, or both; and
(iii) use of the energy attributes by the legal entity to further a charitable and/or environmental purpose.

30. A method for financing an energy generating facility of a type to be built by a developer, said facility being further of a type which generates energy having associated energy attributes, the energy attributes being tradable as a commodity separately from said energy, said method comprising:
calculating a purchase price for at least a portion of said energy attributes to be generated in the operation of said facility;
transferring said ownership rights in said energy attributes to a first legal entity in a manner that effectively severs said ownership rights in said energy attributes from the energy generated;
collecting said purchase price from said first legal entity in exchange for ownership rights in said energy attributes;
selling said energy attributes to a purchaser/contributor to generate revenue; and
transferring said energy attributes to a second legal entity from the purchaser/contributor.

31. A system for financing an energy generating facility of a type to be built by a developer, said facility being further of a type which generates energy having associated energy attributes, the energy attributes being tradable as a commodity separately from said energy, said system comprising a computer-based information handling system adapted for:
calculating a purchase price for at least a portion of said energy attributes to be generated in the operation of said facility;
transferring said ownership rights in said energy attributes to a first legal entity in a manner that effectively severs said ownership rights in said energy attributes from the energy generated;
collecting said purchase price from said first legal entity in exchange for ownership rights in said energy attributes;
selling said energy attributes to a purchaser/contributor to generate revenue; and
transferring said energy attributes to a second legal entity from the purchaser/contributor.

32. A computer readable medium having contents for causing a computer-based information handling system to perform steps for financing an energy generating facility of a type to be built by a developer, said facility being further of a type which generates energy having associated energy attributes, the energy attributes being tradable as a commodity separately from said energy, the steps comprising:
calculating a purchase price for at least a portion of said energy attributes to be generated in the operation of said facility;
transferring said ownership rights in said energy attributes to a first legal entity in a manner that effectively severs said ownership rights in said energy attributes from the energy generated;
collecting said purchase price from said first legal entity in exchange for ownership rights in said energy attributes;
selling said energy attributes to a purchaser/contributor to generate revenue; and
transferring said energy attributes to a second legal entity from the purchaser/contributor.

33. A renewable energy generating facility, the construction of which has been financed, at least in part, by the method of claim 1.
